(19) United States
(12) Patent Application Publication
(10) Pub. No.: US 2004/0095969 A1
(43) Pub. Date: May 20, 2004

(54) Fiber laser apparatus

(75) Inventors: Nobuaki Kaji, Fukaya-shi (JP); Kiyoyuki Kawai, Higashikurume-shi (JP); Ken Ito, Yamato-shi (JP); Hideaki Okano, Fukaya-shi (JP); Masaki Tsuchida, Fukaya-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/673,675

(22) Filed: Sep. 30, 2003

(30) Foreign Application Priority Data
Sep. 30, 2002 (JP) 2002-287123

(51) Int. Cl. H01S 3/30

(52) U.S. Cl. 372/6

(57) ABSTRACT

A fiber laser apparatus comprises a plurality of semiconductor lasers, and an optical fiber which beams emitted from the plurality of semiconductor lasers are caused to enter. The plurality of semiconductor lasers being so arranged that the emitted beams are almost parallel to one another in a slow-axis direction and the incidence angles of the emitted beams to the optical fiber differ from one another in a fast-axis direction.

### CROSS-REFERENCE TO RELATED APPLICATIONS

This application is based upon and claims the benefit of priority from the prior Japanese Patent Application No. 2002-287123, filed Sep. 30, 2002, the entire contents of which are incorporated herein by reference.

### BACKGROUND OF THE INVENTION

1. Field of the Invention

This invention relates to an up-conversion-type fiber laser apparatus. In this type of fiber laser apparatus, rays of light emitted from a plurality of semiconductor lasers are caused to enter a single optical fiber, thereby producing an optical output with a desired wavelength. This type of fiber laser apparatus is used suitably as a light source for, for example, a projection-type image displaying apparatus, such as a projector.

2. Description of the Related Art

In recent years, tremendous effort has been directed toward developing the use of the aforesaid type of fiber laser apparatus as a light source for a projection-type image displaying apparatus, such as a projector. This type of fiber laser apparatus, however, is still being developed and therefore it cannot be said that the apparatus has reached a level that satisfies practical use sufficiently in various respects.

Jpn. Pat. Appln. KOKAI 2002-202442 has disclosed a fiber laser apparatus which causes a condensing optical system composed of a collimator lens and a condenser lens to condense laser beams emitted from a plurality of semiconductor lasers and connects the beams optically at a multi-mode optical fiber. In the fiber laser apparatus disclosed in the document, since the efficiency at which the laser beams are caused to enter the multi-mode optical fiber is low, it is difficult to obtain a high optical output.

### BRIEF SUMMARY OF THE INVENTION

An embodiment of the present invention may provide a fiber laser apparatus which increases the incidence efficiency of laser beams emitted for a plurality of semiconductor lasers to an optical fiber and produces sufficient optical output to be used as a light source for, for example, a projection-type image displaying apparatus.

According to an aspect of the present invention, there is provided A fiber laser apparatus comprising: a plurality of semiconductor lasers; and an optical fiber which beams emitted from the plurality of semiconductor lasers are caused to enter, the plurality of semiconductor lasers being so arranged that the emitted beams are almost parallel to one another in a slow-axis direction and the incidence angles of the emitted beams to the optical fiber differ from one another in a fast-axis direction.

With the above configuration, the beams emitted from a plurality of semiconductor lasers are made almost parallel to one another in the slow-axis direction and caused to enter the optical fiber in such a manner that the optical axes of the beams differ in the fast-axis direction. This makes it possible to cause the beams emitted from the semiconductor lasers to enter the optical fiber efficiently, which enables a high optical output to be produced. Therefore, a fiber laser apparatus with the configuration is suitable for practical use as, for example, a light source for a projection-type image display apparatus.

Additional features and advantages of the invention will be set forth in the description which follows, and in part will be obvious from the description, or may be learned by practice of the invention. The features and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows a fiber laser apparatus according to a first embodiment of the present invention;

FIG. 2 shows an active layer of a semiconductor laser related to the first embodiment; and

FIG. 3 shows a fiber laser apparatus according to a second embodiment of the present invention.

### DETAILED DESCRIPTION OF THE INVENTION

Hereinafter, referring to the accompanying drawings, a first embodiment of the present invention will be explained in detail.

(First Embodiment)

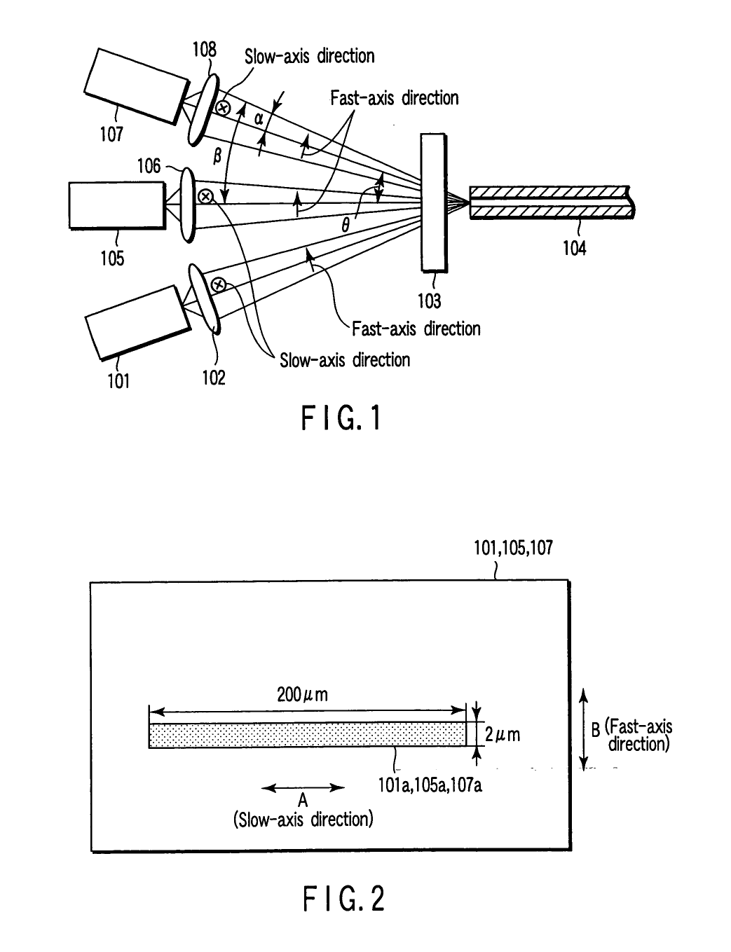

FIG. 1 shows a fiber laser apparatus according to a first embodiment of the present invention. In FIG. 1, numerals 101, 105, 107 each indicate a semiconductor laser, such as a multi-mode laser diode.

The laser beams emitted from the semiconductor lasers 101, 105, 107 pass through circular lenses 102, 106, 108, respectively, and enter a rod lens 103, which condenses the beams onto the incidence end of an optical fiber 104. The optical fiber 104 has a core diameter of 50 μm and a numerical aperture of 0.29.

FIG. 2 shows an active layer of a semiconductor laser related to the first embodiment. In FIG. 2, active layers 101a, 105a, 107a for generating laser beams in the semiconductor lasers 101, 105, 107, respectively, are shown.

The length (or the width) of each of the active layers 101a, 105a, 107a in the slow-axis direction is 200 μm. The length (or the thickness) of each of the active layers 101a, 105a, 107a in the fast-axis direction is 2 μm. The laser beam emitted from each of the active layers 101a, 105a, 107a spreads through an angle of 20° in the fast-axis direction and through an angle of 4° in the slow-axis direction.

The laser image width of the laser beam emitted from the semiconductor laser 101 in the slow-axis direction and fast-axis direction is converted by the circular lens 102 and rod lens 103 so that the width may be almost equal to the core diameter of the optical fiber 104 at the end of the optical fiber 104.

That is, the laser image width of the laser beam emitted from the semiconductor laser 101 in the fast-axis direction is condensed onto the incidence end of the optical fiber 104 by the circular lens 102. The laser image width of the laser beam emitted from the semiconductor laser 101 in the slow-axis direction is condensed onto the incidence end of the optical fiber 104 by the circular lens 102 and rod lens 103.

The laser image width of the laser beam emitted from the semiconductor laser 105 in the slow-axis direction and fast-axis direction is converted by the circular lens 106 and rod lens 103 so that the width may be almost equal to the core diameter of the optical fiber 104 at the end of the optical fiber 104.

The laser image width of the laser beam emitted from the semiconductor laser 107 in the slow-axis direction and fast-axis direction is converted by the circular lens 108 and rod lens 103 so that the width may be almost equal to the core diameter of the optical fiber 104 at the end of the optical fiber 104.

In the first embodiment, the value of (laser image width)×[sin (divergence angle at position of image)] is made constant. The laser image width of each laser beam in the fast-axis direction and slow-axis direction is converted by the optical system (including the circular lenses 102, 106, 108 and the rod lens 103, so that the value may be equal to the value of (the active layer width of the semiconductor laser)×[sin (divergence angle of semiconductor laser at position of emission end)].

In the first embodiment, the value of (active layer width of 200 μm)×[sin (emission divergence angle of 4°)] in the slow-axis direction becomes almost equal to the value of (optical fiber core diameter of 50 μm)×(optical fiber numerical aperture of 0.29).

In contrast, the value of (an active layer width of 2 μm)×[sin (emission divergence angle of 20°)] in the fast-axis direction becomes smaller than the value of (optical fiber core diameter of 50 μm)×(optical fiber numerical aperture of 0.29).

When the image width of the laser beam in the fast-axis direction at the incidence end of the optical fiber 104 is made equal to the core diameter of the optical fiber 104 by the optical system, the divergence angle of the laser beam in the fast-axis direction becomes 0.8°. This value is much smaller than the maximum light-receiving angle (about 16.9°) expressed by the numerical aperture of the optical fiber 104, that is, 0.29.

This makes it possible to cause a plurality of laser beams differing in the angle of the optical axis in the fast-axis direction by (0.8×2)° or more to enter the single optical fiber 104. As a result, the light density in the optical fiber 104 can be increased.

The semiconductor lasers 101, 105, 107 are arranged in such a manner that the optical axes of the laser beams emitted from the semiconductor lasers become almost parallel to one another in the slow-axis direction and are inclined at intervals of 4° in the fast-axis direction.

That is, the laser beams emitted the semiconductor lasers 101, 105, 107 are caused to enter the incidence end of the optical fiber 104 in such a manner that their incidence angles differ from one another by 4° in the fast-axis direction. Let the angle difference be θ.

In the first embodiment, the full divergence angle 2α (=1.6°) in the fast-axis direction of a laser beam caused to enter the optical fiber 104 is made smaller than the inter-optical-axis angle θ (=4°) of the adjacent laser beam in the fast-axis direction. The maximum incidence angle β (=4.8°) of all the laser beams in the fast-axis direction is made smaller than the maximum incidence angle (about 16.9°) of the optical fiber 104. This makes all the laser beams enter the optical fiber 104 efficiently, which produces a high optical output.

Generally, in a semiconductor laser, the value of (active layer width in slow-axis direction)×[sin (emission divergence angle in slow-axis direction)] is larger than the value of (active layer width in fast-axis direction)×[sin (emission divergence angle in fast-axis direction)].

When the value of (active layer width in slow-axis direction)×[sin (emission divergence angle in slow-axis direction)] is larger than the value of (core diameter of optical fiber)×(numerical aperture of optical fiber), even all of the emitted laser beam from only one semiconductor laser cannot enter the optical fiber.

Therefore, it is desirable that the value of (active layer width in slow-axis direction)×[sin (emission divergence angle in slow-axis direction)] should be equal to or smaller than the value of (core diameter of optical fiber)×(numerical aperture of optical fiber).

Generally, when the sum of the values of (active layer width in fast-axis direction)×[sin (emission divergence angle in fast-axis direction)] is larger than the value of (core diameter of optical fiber)×(numerical aperture of optical fiber), all of the laser beams emitted from the individual semiconductor lasers cannot enter the optical fiber. Therefore, the sum of the values of (active layer width in fast-axis direction)×[sin (emission divergence angle in fast-axis direction)] should be equal to or smaller than the value of (core diameter of optical fiber)×(numerical aperture of optical fiber).

(Second Embodiment)

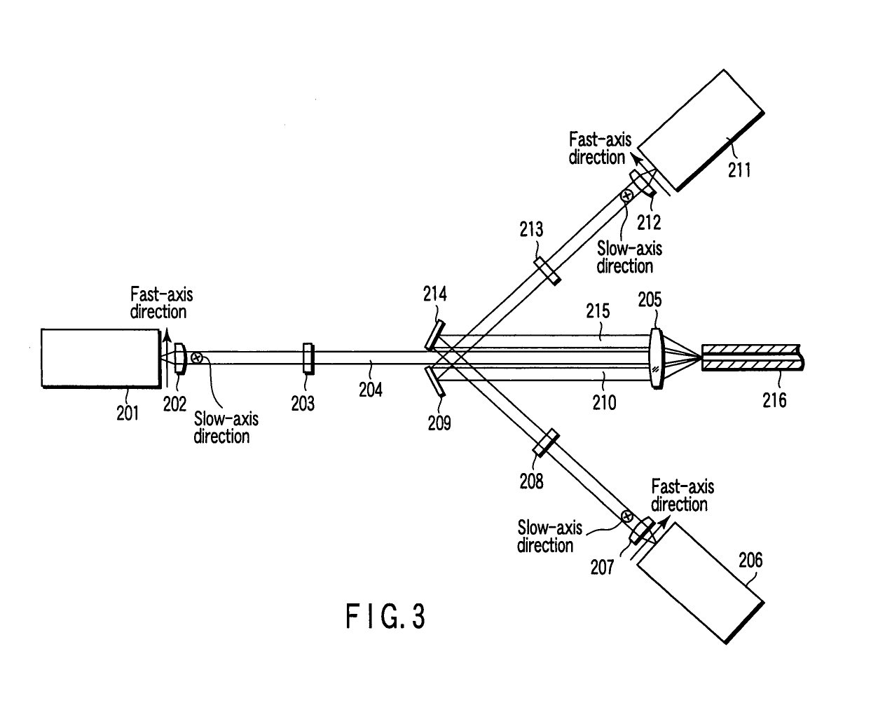

FIG. 3 shows a fiber laser apparatus according to a second embodiment of the present invention. In FIG. 3, rays of laser light 204 emitted from a semiconductor laser 201 are collimated by a cylindrical lens 202 in the fast-axis direction and then by a cylindrical lens 203 in the slow-axis direction. Thereafter, the rays of laser light 204 made almost parallel to one another are condensed by a condenser lens 205 onto the incidence end of an optical fiber 216, with the result that the parallel rays of laser light 204 enter the optical fiber 216.

Similarly, rays of laser light 215 emitted from a semiconductor laser 206 are collimated by cylindrical lenses 207 and 208 in the fast-axis direction and in the slow-axis direction, respectively. Thereafter, their optical paths are bent by a total reflection mirror 214. As a result, the rays of laser light 215 are condensed by the condenser lens 205 onto the incidence end of the optical fiber 216, causing the rays of laser light 215 to enter the optical fiber 216.

Furthermore, rays of laser light 210 emitted from a semiconductor laser 211 are collimated by cylindrical lenses 212 and 213 in the fast-axis direction and in the slow-axis direction, respectively. Thereafter, their optical paths are bent by a total reflection mirror 209. As a result, the rays of laser light 210 are condensed by the condenser lens 205 onto the incidence end of the optical fiber 216, causing the rays of laser light 210 to enter the optical fiber 216.

The optical axes of the three laser lights 204, 215, 210 caused to enter the condenser lens 205 are at different distances from the central axis of the condenser lens 205 in the fast-axis direction. For this reason, each of the laser lights 204, 215, 210 is caused to enter the incidence end of the optical fiber 216 at a different angle in the fast-axis direction.

In the second embodiment, the optical paths of the laser beams emitted from the semiconductor lasers 206, 211 are bent by the total reflection mirrors 214, 209, which makes it unnecessary to provide the semiconductor lasers 206, 211 next to the semiconductor laser 201. This increases the degree of freedom in terms of structure.

This invention is not limited to the above embodiments and may be practiced and embodied in still other ways without departing from the spirit or essential character thereof.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fiber laser apparatus comprising:
a plurality of semiconductor lasers; and
an optical fiber which beams emitted from said plurality of semiconductor lasers are caused to enter, said plurality of semiconductor lasers being so arranged that the emitted beams are almost parallel to one another in a slow-axis direction and the incidence angles of the emitted beams to the optical fiber differ from one another in a fast-axis direction.

2. The fiber laser apparatus according to claim 1, wherein the value of (active layer width in slow-axis direction)×[sin (emission divergence angle in slow-direction angle)] of each of the semiconductor lasers is set equal to or smaller than the value of (core diameter)×(numerical aperture) of the optical fiber.

3. The fiber laser apparatus according to claim 1, wherein the sum of the values of (active layer width in fast-axis direction)×[sin (emission divergence angle in fast-direction angle)] of said plurality of semiconductor lasers is set equal to or smaller than the value of (core diameter)×(numerical aperture) of the optical fiber.

4. The fiber laser apparatus according to claim 1, further comprising a mirror which changes the optical path of at least one of the beams emitted from said plurality of semiconductor lasers and causes the beam to enter the optical fiber.

5. The fiber laser apparatus according to claim 1, wherein the beams emitted from said plurality of semiconductor lasers are caused to enter the optical fiber with a specific angle difference between their optical axes of the beams in the fast-axis direction.
